(19) United States
(12) Patent Application Publication
(10) Pub. No.: US 2010/0233377 A1
(43) Pub. Date: Sep. 16, 2010

(54) IMPRINT APPARATUS AND METHOD

(75) Inventors: Akio Aoki, Shimotsuga-gun (JP); Hiroshi Inada, Utsunomiya-shi (JP); Tohru Kohda, Utsunomiya-shi (JP); Hideki Ina, Tokyo (JP); Hiroshi Sato, Utsunomiya-shi (JP)

Correspondence Address: ROSSI, KIMMS & McDOWELL LLP., 20609 Gordon Park Square, Suite 150, Ashburn, VA, 20147, US

(73) Assignee: CANON KABUSHIKI KAISHA, Tokyo (JP)

(21) Appl. No.: 12/721,799

(22) Filed: Mar. 11, 2010

(30) Foreign Application Priority Data
Mar. 11, 2009 (JP) 2009-058701
Feb. 16, 2010 (JP) 2010-030898

(51) Int. Cl. B05D 3/12

(52) U.S. Cl. 427/355

(57) ABSTRACT

An imprint apparatus which includes an imprint head configured to hold a mold, and performs an imprint process including dispensing of a resin to a shot region on a substrate and pressing of the mold and the dispensed resin with each other, comprises a controller configured to control an order of the imprint process for a plurality of selected shot regions on the substrate, and a first dispenser and a second dispenser configured to dispense the resin, wherein the first dispenser is arranged on a side of a first direction with respect to the imprint head, and the second dispenser is arranged on a side of a second direction opposite to the first direction with respect to the imprint head.

### BACKGROUND OF THE INVENTION

1. Field of the Invention

The present invention relates to an imprint apparatus and method.

2. Description of the Related Art

Nano-imprinting is a technique of enabling transfer of nanometer scale fine patterns and is well on its way to practical use as a nanolithography technique applicable to the mass production of magnetic storage media or semiconductor devices. In nano-imprinting, a fine pattern is formed on a substrate such as a silicon wafer or a glass plate using, as a mask, a mold with a fine pattern formed by an apparatus such as an electron-beam exposure apparatus. The fine pattern is formed by dispensing a nanoimprint resin to the substrate and curing the resin on the substrate, which is being pressed by the mold.

Nano-imprint techniques currently in practical use are the heat-cycle method and the photocuring method. In the heat-cycle method, a thermoplastic nanoimprint resin on a substrate is heated to the glass transition temperature or higher temperature to raise the fluidity, and the mold is pressed against the fluidized resin. The mold is separated from the resin after cooling, thereby forming a pattern. In the photocuring method, a UV curable nanoimprint resin is used. The mold is pressed against the resin on the substrate. In this state, the resin is cured by UV irradiation. The mold is then separated from the cured resin, thereby forming a pattern. In the heat-cycle method, temperature control prolongs the transfer time, and the dimensional accuracy lowers due to temperature changes. However, the photocuring method has no such problems and is therefore advantageous in mass-producing nanometer scale semiconductor devices at present.

A variety of nanoimprint apparatuses have been put into practical use so far in accordance with resin curing methods and application purposes. On the premise that the apparatus is oriented to mass production of semiconductor devices or the like, it is effective to repeat imprint resin dispensing and pattern transfer for each shot region on the substrate. Japanese Patent No. 4185941 discloses such an apparatus. This nanoimprint apparatus includes a substrate stage, nanoimprint resin dispensing mechanism, imprint head, light irradiation system, and alignment mark detection mechanism.

The above-mentioned nanoimprint apparatus can repeat processes of moving a shot region under the dispensing mechanism and dispensing the resin to the shot region, and then moving the shot region under the mold and pressing the mold against the substrate. Hence, the time required to move the substrate is demanded to be shorter.

### SUMMARY OF THE INVENTION

The present invention provides, for example, an imprint apparatus and method advantageous in terms of throughput thereof.

One of aspects of the present invention provides an imprint apparatus which includes an imprint head configured to hold a mold, and performs an imprint process including dispensing of a resin to a shot region on a substrate and pressing of the mold and the dispensed resin with each other, the apparatus comprising a controller configured to control an order of the imprint process for a plurality of selected shot regions on the substrate, and a first dispenser and a second dispenser configured to dispense the resin, wherein the first dispenser is arranged on a side of a first direction with respect to the imprint head, and the second dispenser is arranged on a side of a second direction opposite to the first direction with respect to the imprint head, the substrate is arranged so as to make rows of a layout of the plurality of shot regions parallel with the first direction and the second direction, the first dispenser dispenses the resin to shot regions belonging to a first group of the layout, and the second dispenser dispenses the resin to shot regions belonging to a second group of the layout, the first group existing on a side of the first direction, the second group existing on a side of the second direction, and a difference between number of shot regions belonging to an rth (r is a natural number) row of the first group and number of shot regions belonging to the rth row of the second group being not more than 1, and the controller is configured to control the order so as to satisfy a first condition that if the imprint process has ended for all selected shot regions of one row of the layout, the imprint process is executed for selected shot regions of a next row of the layout, a second condition that a plurality of shot regions belonging to a rth row selected from the first group undergo the imprint process sequentially in an rth row selected direction that is parallel to the first direction and the second direction, a third condition that a plurality of shot regions belonging to the rth row selected from the second group undergo the imprint process sequentially in the rth row selected direction, and a fourth condition that with respect to one row of the layout, the selected shot regions of the first group and the selected shot regions of the second group alternately undergo the imprint process as long as it is possible.

Further features of the present invention will become apparent from the following description of exemplary embodiments with reference to the attached drawings.

### BRIEF DESCRIPTION OF THE DRAWINGS

FIG. 1 is a view illustrating an imprint order according to the first embodiment;

FIGS. 2A to 2C are views for explaining the principle of imprint by the photocuring method;

FIG. 3 is a view showing the schematic arrangement of an imprint apparatus according to a preferred embodiment;

FIGS. 4A to 4E are views illustrating the imprint operation of the imprint apparatus according to the preferred embodiment;

FIG. 5 is a view illustrating a method of dividing shot regions on a substrate into two groups;

FIG. 6 is a flowchart illustrating the procedure of the imprint process of the imprint apparatus according to the preferred embodiment of the present invention;

FIG. 7 is a view illustrating an imprint order according to the second embodiment;

FIGS. 8A to 8E are views illustrating the imprint operation of an imprint apparatus according to still another preferred embodiment; and

FIG. 9 is a view illustrating the imprint operation of the imprint apparatus according to the other preferred embodiment.

### DESCRIPTION OF THE EMBODIMENTS

Preferred embodiments of the present invention will now be described in detail with reference to the accompanying drawings.

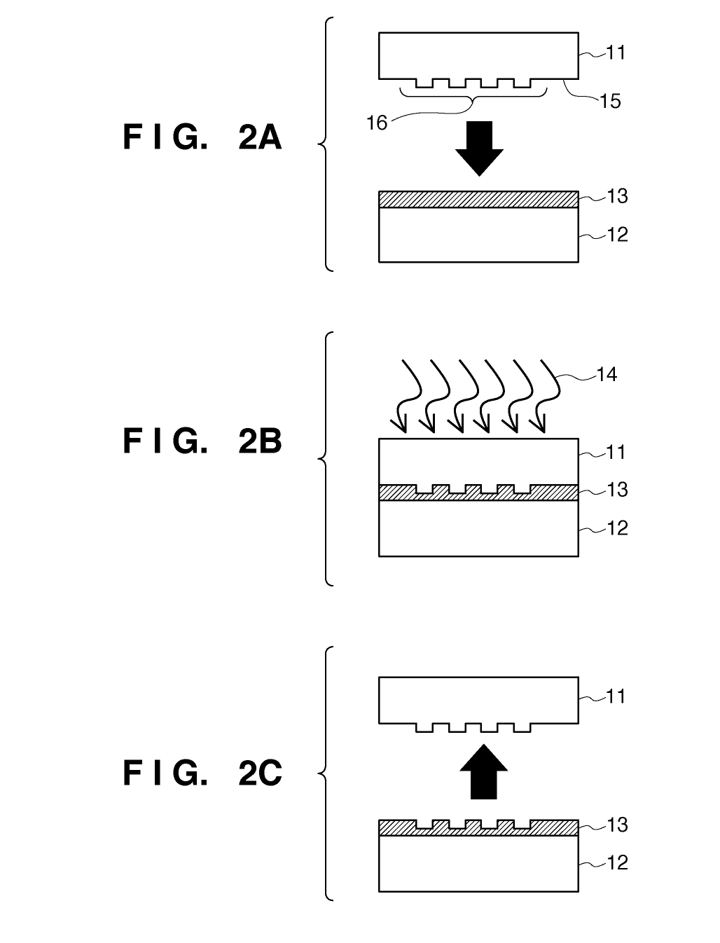

The principle of imprint by the photocuring method will be explained with reference to FIGS. 2A to 2C. In the step of FIG. 2A, an imprint resin (to be referred to as a resin hereinafter) 13 is dispensed to a substrate 12. A patterned surface 15 of a mold 11 is pressed against the resin 13 on the substrate 12. In this example, the resin 13 is curable when irradiated with light such as UV light. The mold 11 is made of a UV transmitting material such as quartz. A pattern 16 is formed on the patterned surface 15. When the patterned surface 15 of the mold 11 is pressed against the resin 13 on the substrate 12 such as a silicon wafer or a glass plate, the resin 13 enters the concave portions of the pattern 16 due to capillarity.

In the step of FIG. 2B, in the state in which the mold 11 is pressed against the resin 13 on the substrate 12, UV light 14 irradiates the resin 13 through the mold 11. The UV light 14 cures the resin 13 so as to transfer the pattern 16 of the mold 11 to the substrate 12. In this specification, forming or transferring a pattern to the substrate by the imprint technique represented by the nanoimprint technique is called “imprint”.

In the step of FIG. 2C, the mold 11 separates from the resin 13 on the substrate 12. The resin 13 having a shape conforming to the pattern 16 of the mold 11 remains on the substrate 12. After separating the mold 11, the transferred pattern of the resin 13 can serve as an equivalent to a resist pattern formed by lithography of a conventional exposure apparatus. Subsequent processes in the manufacture of semiconductor devices are the same as in the exposure apparatus.

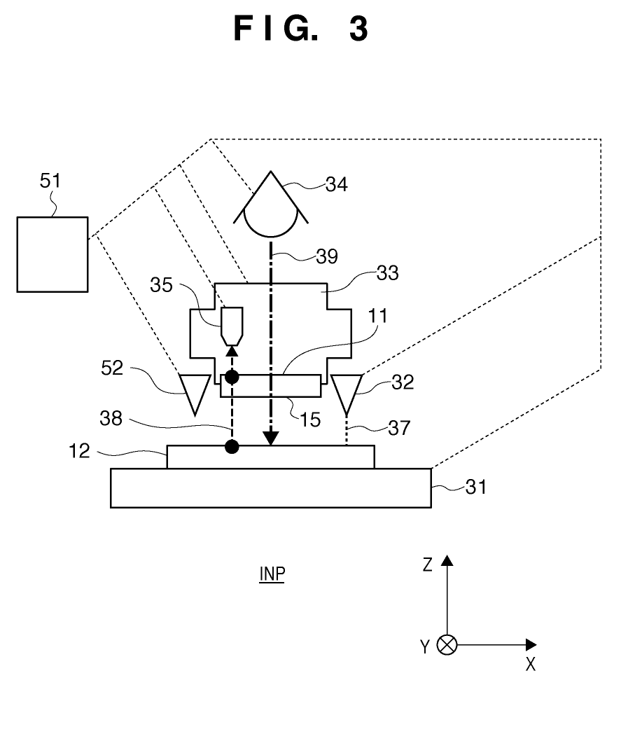

An imprint apparatus INP according to the preferred embodiment of the present invention will be described with reference to FIG. 3. The imprint apparatus INP is configured to imprint a pattern to a shot region on the substrate 12 by dispensing the resin to the shot region and curing the resin on the substrate, which is being pressed by the patterned surface 15 of the mold 11. The imprint apparatus INP includes an imprint head 33, a controller 51 which controls the imprint order of a plurality of selected shot regions on the substrate, and a first dispenser 32 and a second dispenser 52 which dispense the resin to an imprint target shot region. In this embodiment, the origin in the X- and Y-axis directions is set to coincide with the center of the imprint head 33.

In this embodiment, the resin is a photocuring resin that is curable when irradiated with light, and the imprint apparatus INP includes a light irradiation system 34 that irradiates the resin with light 39 through the mold 11. The light irradiation system 34 irradiates the resin with light when the patterned surface 15 of the mold 11 is pressed against the resin on the substrate 12. As another practice, the resin is curable upon receiving another physical energy such as heat or when chemically changed. Each of the first dispenser 32 and the second dispenser 52 has, e.g., a plurality of nozzles so as to adjust the dispensing width by selecting the number of nozzles to discharge the resin.

The first dispenser 32 is arranged in the first direction (+X direction) with respect to (the center of) the imprint head 33. The second dispenser 52 is arranged in the direction opposite to the first direction (+X direction), i.e., in the second direction (−X direction) with respect to the imprint head 33. The first dispenser 32 and the second dispenser 52 can be arranged such that the first dispenser 32, the second dispenser 52, and the center (or origin) of the imprint head 33 are aligned in line with each other.

The imprint head 33 has a mold chuck for holding the mold 11. An actuator (not shown) drives the imprint head 33 in a vertical direction (Z-axis direction) while the mold chuck of the imprint head 33 holds the mold 11. When the actuator drives the imprint head 33 downward, the patterned surface 15 of the mold 11 is pressed against the resin on the substrate 12. When the actuator drives the imprint head 33 upward, the patterned surface 15 of the mold 11 separates from the resin on the substrate 12.

The imprint apparatus INP includes a substrate driving mechanism 31 which drives the substrate 12 held by a substrate chuck (not shown). The substrate driving mechanism 31 can control the position of the substrate 12 along at least two axes, i.e., X and Y-axis directions which are perpendicular to the Z-axis direction in the XYZ coordinate system. The imprint apparatus INP can include a detector 35 that detects the misalignment between the mold 11 and the substrate 12. The detector 35 can detect the misalignment between the mold 11 and the substrate 12 by, for example, optically detecting marks formed on the mold 11 and those formed on the substrate 12. Reference numeral 38 schematically represents the detection optical axis of the detector 35.

The controller 51 can be configured to control the imprint order of a plurality of selected shot regions on the substrate and also control, for example, the substrate driving mechanism 31, first dispenser 32, second dispenser 52, light irradiation system 34, and detector 35.

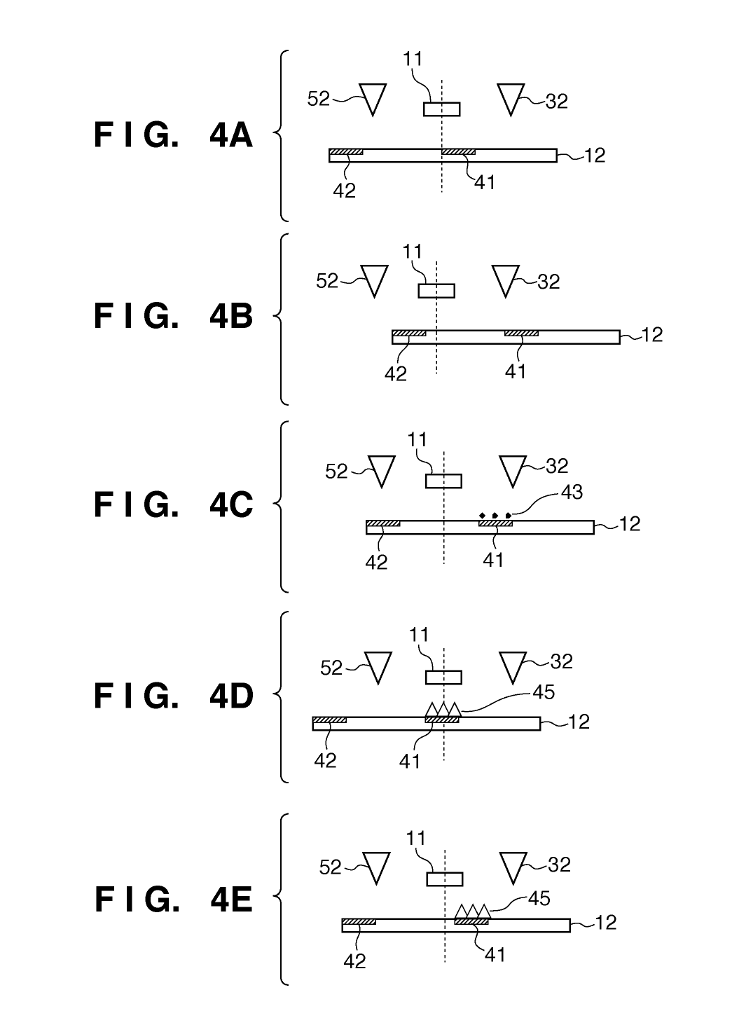

The imprint operation of the imprint apparatus according to the preferred embodiment of the present invention will be exemplified with reference to FIGS. 4A to 4E. FIG. 4A shows a state in which the center of the substrate 12 exists immediately under the mold 11 held by the imprint head 33. Reference numeral 41 denotes a shot region near the center of the substrate 12; and 42, a shot region near the outer edge of the substrate 12. FIG. 4B shows a state immediately before the first dispenser 32 starts dispensing the resin to the shot region 41 on the substrate 12. At this time, the vicinity of the center of the substrate 12 is located almost immediately under the first dispenser 32. FIG. 4C shows a state immediately after the first dispenser 32 has ended resin dispensing to the shot region 41 on the substrate. During the transition from the state in FIG. 4B to the state shown in FIG. 4C, resin dispensing by the first dispenser 32 and substrate driving by the substrate driving mechanism 31 are performed in parallel to dispense a resin 43 all over the shot region 41. FIG. 4D shows a state immediately after imprint (that is, immediately after the resin dispensed to the shot region 41 on the substrate 12 has been cured while the mold 11 is pressed against the resin on the substrate 12, and the mold 11 has been separated from the resin). The pattern formed on the patterned surface of the mold 11 is transferred to the resin on the substrate 12 upon imprint, thereby forming a pattern 45. FIG. 4E shows a state immediately before the second dispenser 52 starts resin dispensing to the shot region 42 on the substrate 12.

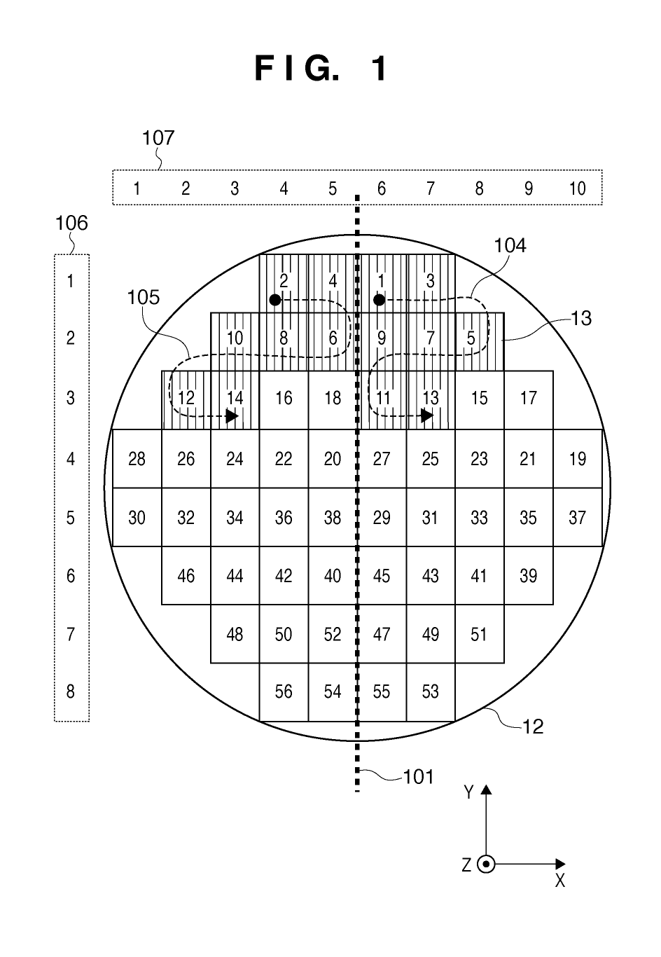

An imprint order according to the first embodiment of the present invention will be exemplified with reference to FIG. 1. Referring to FIG. 1, each rectangle within the region on the substrate 12 represents a shot region. The number in each rectangle indicates the order of imprint. In the example of FIG. 1, the shot regions are laid out to be symmetrical with respect to the Y-axis.

The rows of the layout of the plurality of shot regions on the substrate 12 are defined to run in the X direction. The columns of the layout are defined to run in the Y direction. The shot regions of each row are divided into a first group on the +X direction (first direction) side and a second group on the −X direction (second direction) side. The division is done such that the difference between the number of shot regions belonging to the rth (r is a natural number) row of the first group and the number of shot regions belonging to the rth row of the second group is 1 or less. In the example of FIG. 1, the layout of the plurality of (all) shot regions on the substrate 12 is symmetrical with respect to a division boundary 101 serving as an axis of symmetry. Hence, the difference between the number of shot regions belonging to the rth row of the first group and the number of shot regions belonging to the rth row of the second group is 0 in all rows.

An arrow 104 indicates the imprint order of the shot regions belonging to the first group. An arrow 105 indicates the imprint order of the shot regions belonging to the second group. Reference numeral 106 indicates row numbers (r) in the shot region layout on the substrate; and 107 indicate column numbers in the layout. The first dispenser 32 dispenses the resin to selected shot regions belonging to the first group, whereas the second dispenser 52 dispenses the resin to selected shot regions belonging to the second group.

The controller 51 controls the imprint order of the plurality of selected shot regions on the substrate 12 so as to satisfy the following first, second, third, and fourth conditions. The selected shot regions mean shot regions selected from all shot regions on the substrate 12 as targets to form a specific pattern by imprint. Either all or some of the shot regions on the substrate 12 can be selected. In the example of FIG. 1, all shot regions on the substrate 12 are selected.

(First condition) When imprint has ended for all the selected shot regions belonging to one row, imprint for the selected shot regions belonging to the next row is executed.

(Second condition) Out of the selected shot regions belonging to the first group, shot regions belonging to the rth row undergo imprint in an order according to the rth row selected direction that is parallel to the first direction (+X direction) and the second direction (−X direction).

(Third condition) Out of the selected shot regions belonging to the second group, shot regions belonging to the rth row undergo imprint in an order according to the rth row selected direction.

(Fourth condition) The selected shot regions belonging to the first group and those belonging to the second group alternately undergo imprint as long as it is possible.

In the example of FIG. 1, the layout of the selected shot regions included in the first group and that of the selected shot regions included in the second group are symmetrical. Hence, imprint for the selected shot regions belonging to the first group and imprint for the selected shot regions belonging to the second group are alternately executed.

In the example of FIG. 1, when imprint has ended for the selected shot regions (indicated by 1 to 4) belonging to the first row, imprint for the selected shot regions (indicated by 5 to 10) belonging to the second row is executed (first condition). In a similar manner, when imprint has ended for all the selected shot regions belonging to the rth row, imprint for the selected shot regions belonging to the (r+1)th row is executed (first condition).

Out of the selected shot regions belonging to the first group, shot regions belonging to the rth row undergo imprint in the order according to the rth row selected direction (indicated by the arrow 104) that is parallel to the first direction (+X direction) and the second direction (−X direction) (second condition). In addition, out of the selected shot regions belonging to the second group, shot regions belonging to the rth row undergo imprint in the order according to the rth row selected direction (indicated by the arrow 105) (third condition). The selected shot regions belonging to the first group and those belonging to the second group alternately undergo imprint (fourth condition). For example, shot region “1” in the first row of the first group, shot region “2” in the first row of the second group, shot region “3” in the first row of the first group, and shot region “4” in the first row of the second group undergo imprint in this order.

The imprint order of the shot regions in each row of each group is preferably decided such that when r is an odd number, the rth row selected direction is the first direction (+X direction), and when r is an even number, the rth row selected direction is the second direction (−X direction). Alternatively, the imprint order of the shot regions in each row of each group is preferably decided such that when r is an odd number, the rth row selected direction is the second direction (−X direction), and when r is an even number, the rth row selected direction is the first direction (+X direction). Setting the rth row selected direction in the odd-numbered rows and that in the even-numbered rows to be opposite to each other is effective for reducing the substrate moving amount and improving throughput. In other words, setting the rth row selected direction for r=r0 and that for r=r0+1 to be opposite to each other is advantageous in terms of throughput.

The imprint order shown in FIG. 1 can be expressed by the following equations. Note that the results of the operations of these equations are rounded into integers by dropping fractions below the decimal point.

O1(i)=N_{X}/2+i

O2(i)=N_{X}/2−n(j)/2+i

E1(i)=(N_{X}+1)/2+n(j)/2−(i−1)

E2(i)=(N_{X}+1)/2−(i−1)

where O1(i) is the number of the column of a shot region which undergoes imprint for the ith time out of the shot regions belonging to an odd-numbered row of the first group, O2(i) is the number of the column of a shot region which undergoes imprint for the ith time out of the shot regions belonging to the odd-numbered rows of the second group, E1(i) is the number of the column of a shot region which undergoes imprint for the ith time out of the shot regions belonging to an even-numbered row of the first group, E2(i) is the number of the column of a shot region which undergoes imprint for the ith time out of the shot regions belonging to an even-numbered row of the second group, N_{X} is the number of shot regions (i.e., the number of columns) of a row that includes shot regions at the maximum, and n(r) is the number of shot regions of the rth row.

In the shot region (selected shot region) layout example of FIG. 1, the first to fourth conditions can be satisfied even when performing imprint first for shot regions 4, 3, 2, 55, 54, 56, and 53 in this order.

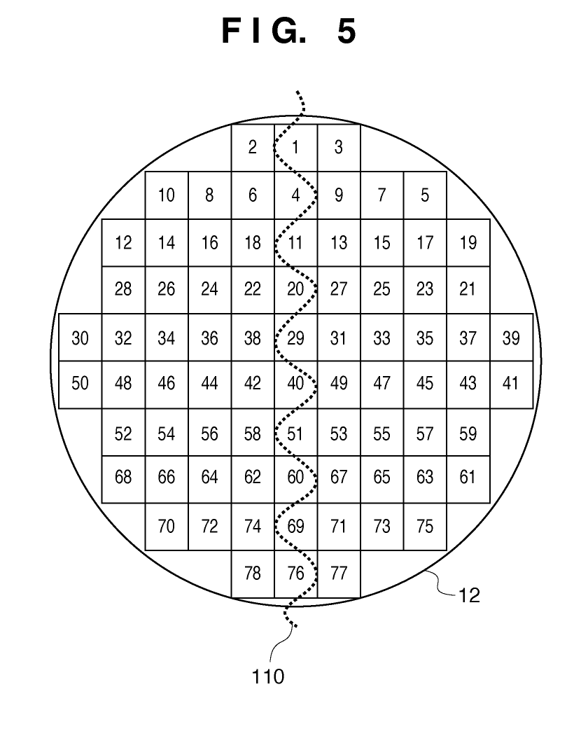

In the example of FIG. 5, the difference between the number of shot regions belonging to the rth (r is a natural number) row of the first group and the number of shot regions belonging to the rth row of the second group is 1 in all rows. In the example of FIG. 5, a division boundary 110 divides the plurality of shot regions on the substrate 12 into the first group and the second group. Each rectangle within the region on the substrate 12 represents a shot region. The number in each rectangle indicates the order of imprint. In the example of FIG. 5 as well, the first to fourth conditions are satisfied.

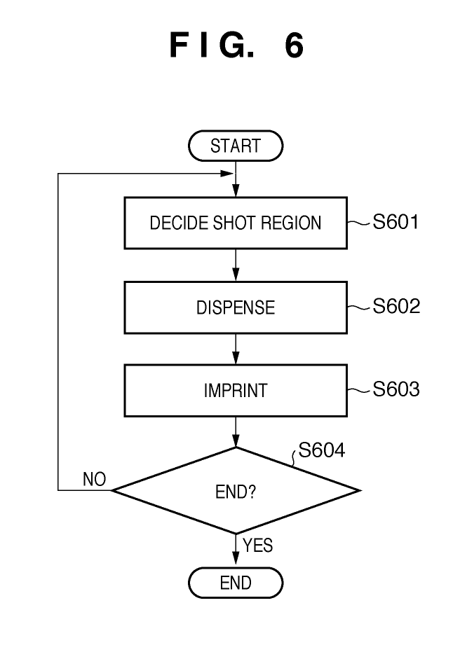

The procedure of the imprint process of the imprint apparatus INP will be exemplified with reference to FIG. 6. This imprint process can be controlled by the controller 51. In step S601, the controller 51 decides the next imprint target shot region in accordance with the imprint order that satisfies the first to fourth conditions. The imprint order can be decided in advance so as to satisfy the first to fourth conditions and set in the controller 51. Alternatively, the controller 51 may decide the imprint order based on the layout of the plurality of (all) shot regions on the substrate and the selected shot regions.

In step S602, the controller 51 controls the substrate driving mechanism 31, first dispenser 32, and second dispenser 52 to dispense the resin to the imprint target shot region. If the imprint target shot region belongs to the first group, the first dispenser 32 dispenses the resin to the shot region. If the imprint target shot region belongs to the second group, the second dispenser 52 dispenses the resin to the shot region.

In step S603, the controller controls the substrate driving mechanism 31, imprint head 33, and light irradiation system 34 to execute imprint for the shot region with the dispensed resin. The operation at this time is, for example, as follows. First, the substrate driving mechanism 31 aligns the shot region having the dispensed resin with the imprint head 33. Next, the imprint head 33 is pressed against the resin in the shot region. In this state, the light irradiation system 34 irradiates the resin with light to cure the resin. Then, the imprint head 33 is separated from the cured resin.

In step S604, the controller 51 determines whether the process of all imprint target shot regions has ended. If the process has not ended, the process returns to step S601. If the process has ended, the imprint process of one substrate ends.

The second embodiment of the present invention will be explained below. When a plurality of shot regions are arranged on a substrate in close vicinity to each other, it may be necessary to consider the resin at the boundary between the shot regions. When etching the underlying layer using the pattern formed by imprint, a gap in the resin between the shot regions causes etching of the layer at the gap portion. To the contrary, excess dispensing to a shot region may make the resin enter an adjacent shot yet to undergo imprint, and impede imprint for the adjacent shot.

In consideration of these problems, a useful layout is adopted in which a checkered pattern is formed by first shot regions where a first pattern should be formed and second shot regions where a second pattern having an area larger than the first pattern should be formed. The first and second patterns can be formed using a single mold 11. In this case, the first and second patterns can selectively be formed by changing the amount of the resin to be dispensed to the first and second shot regions. Alternatively, the first and second patterns may be formed using different molds 11.

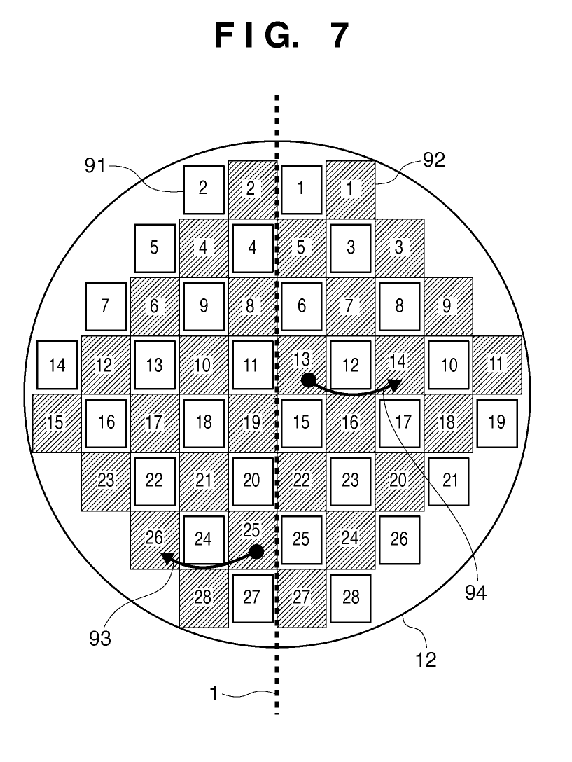

In the example of FIG. 7, first shot regions 91 where the first pattern should be formed and second shot regions 92 where the second pattern having an area larger than the first pattern should be formed are laid out in a checkered pattern. The size of the second shot region 92 is decided so as to, e.g., cover the scribe lines. In FIG. 7, the number in each rectangle indicates the order of imprint.

In the example of FIG. 7, the imprint order controlled by a controller 51 is set or decided in the following way. First, the plurality of first shot regions 91 are selected as imprint target shot regions. The plurality of selected first shot regions 91 undergo imprint in the order that satisfies the first to fourth conditions. Next, the plurality of second shot regions 92 are selected as imprint target shot regions. The plurality of selected second shot regions 92 undergo imprint in the order that satisfies the first to fourth conditions.

When imprint cannot be alternately executed for the first shot regions 91 and the second shot regions 92, performing imprint for the shot regions in the order indicated by arrows 93 and 94 in FIG. 7 is preferable in terms of throughput. According to the second and third conditions, imprint is performed for the shot regions from the outer side to the inner side of the substrate. However, the order is reversed, as indicated by the arrows 93 and 94, to improve throughput. For this purpose, a fifth condition may be added to perform imprint for the shot regions from the inner side to the outer side of the substrate when continuously executing imprint for at least two shot regions belonging to the first shot regions 91 or the second shot regions 92.

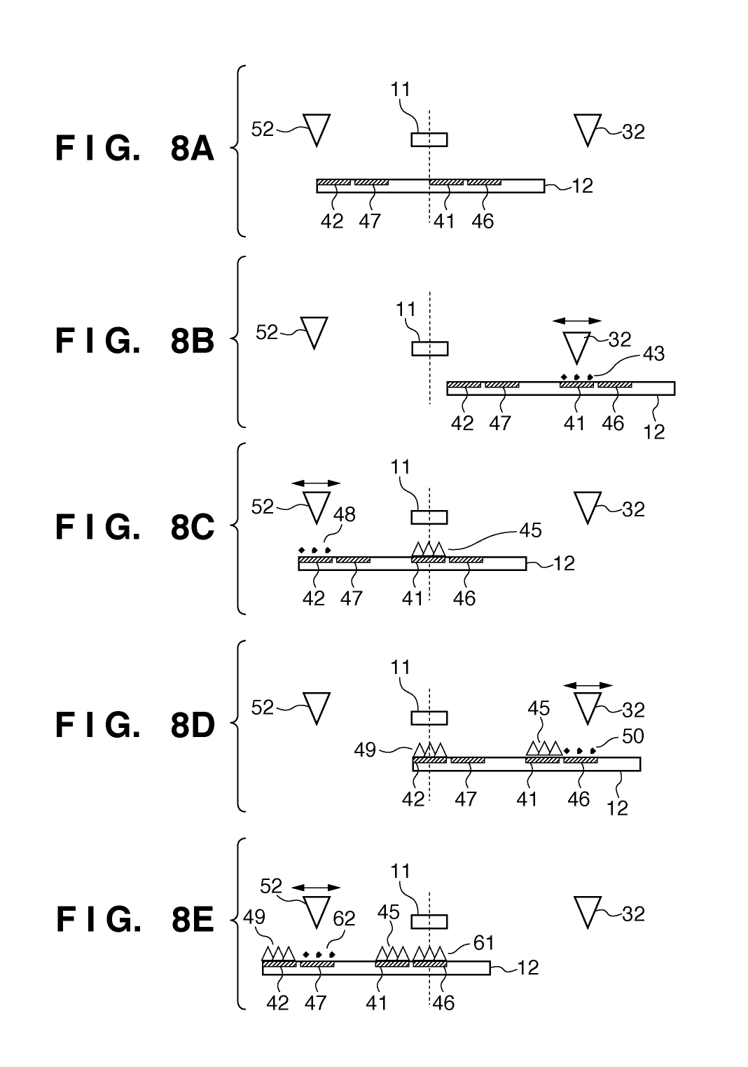

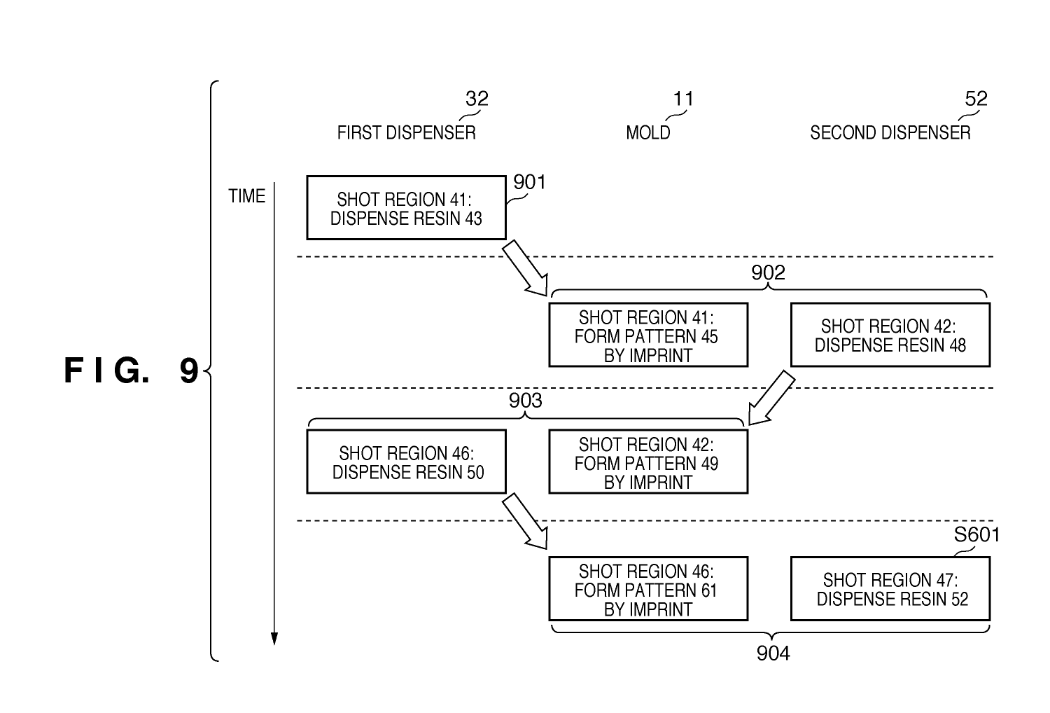

The imprint operation of an imprint apparatus according to still another preferred embodiment of the present invention will be exemplified with reference to FIGS. 8A to 8E. FIG. 9 illustrates the sequence of the imprint operation shown in FIGS. 8A to 8E. In the embodiment shown in FIGS. 8A to 8E, a first dispenser 32 and a second dispenser 52 are movable. The first dispenser 32 and the second dispenser 52 can dispense the resin to a substrate 12 at rest while moving.

FIG. 8A shows a state in which the center of the substrate 12 exists immediately under a mold 11 held by an imprint head 33. Reference numerals 41 and 46 indicate examples of shot regions near the center of the substrate 12 and also examples of first shot regions belonging to the first group. Reference numerals 42 and 47 indicate examples of shot regions near the outer edge of the substrate 12 and also examples of second shot regions belonging to the second group. The first group consists of first shot regions existing on a side of a positive direction in the X-axis direction. The second group consists of second shot regions existing on a side of a positive direction in the X-axis direction.

FIG. 8B shows a state in which the first dispenser 32 is dispensing the resin to the shot region 41 on the substrate 12. A substrate driving mechanism 31 drives the substrate 12 to locate the shot region 41 almost immediately under the first dispenser 32. After that, the first dispenser 32 dispenses a resin 43 to the shot region 41 while moving (901).

FIG. 8C shows a state in which the substrate driving mechanism 31 has driven the substrate 12 to locate, immediately under the mold 11, the shot region 41 with the resin 43 dispensed by the first dispenser 32, and imprint (pressing of the mold 11) has been executed for the shot region 41. Upon imprint, the pattern of the mold 11 is transferred to the resin 43, thereby forming a pattern 45 (902). In parallel to the imprint operation (pressing of the mold 11), the second dispenser 52 dispenses a resin 48 to the shot region 42 while moving (902).

FIG. 8D shows a state in which the substrate driving mechanism 31 has driven the substrate 12 to locate, immediately under the mold 11, the shot region 42 with the resin 48 dispensed by the second dispenser 52, and imprint (pressing of the mold 11) has been executed for the shot region 42. Upon imprint, the pattern of the mold 11 is transferred to the resin 48, thereby forming a pattern 49 (903). In parallel to the imprint operation (pressing of the mold 11), the first dispenser 32 dispenses a resin 50 to the shot region 46 while moving (903).

FIG. 8E shows a state in which the substrate driving mechanism 31 has driven the substrate 12 to locate, immediately under the mold 11, the shot region 46 with the resin 50 dispensed by the first dispenser 32, and imprint (pressing of the mold 11) has been executed for the shot region 46. Upon imprint, the pattern of the mold 11 is transferred to the resin 50, thereby forming a pattern 61 (904). In parallel to the imprint operation (pressing of the mold 11), the second dispenser 52 dispenses a resin 62 to the shot region 47 while moving (904).

According to the embodiment shown in FIGS. 8A to 8E, the dispensers dispense the resin to the shot regions while moving in the above-described way. It is therefore possible to dispense the resin to the next shot region during the imprint operation using the mold 11. This shortens the production time because the time required for resin dispensing to a shot region is included in the period of the imprint operation. The positional relationship between the mold 11 and the first dispenser 32 and second dispenser 52 at the start of movement can arbitrarily be set. The positional relationship can be set in accordance with, e.g., the size or layout of the shot regions.

The controller 51 decides the start position for dispensing to the resin dispensing target shot region based on layout information representing the layout of the shot regions, and moves the corresponding one of the first dispenser 32 and the second dispenser 52 to the start position. Next, the controller 51 causes the corresponding one of the first dispenser 32 and the second dispenser 52 to dispense the resin to the resin dispensing target shot region while moving the dispenser across the shot region. The first dispenser 32 dispenses the resin to selected shot regions belonging to the first group, whereas the second dispenser 52 dispenses the resin to selected shot regions belonging to the second group. The layout information is typically provided to the controller 51 prior to the process of a lot including one or a plurality of substrates.

In the above example, the second dispenser 52 dispenses the resin to the next imprint target shot region belonging to the second group in parallel to imprint for a shot region belonging to the first group. Additionally, the first dispenser 32 dispenses the resin to the next imprint target shot region belonging to the first group in parallel to imprint for a shot region belonging to the second group.

The following control is also useful in place of the above example. The second dispenser 52 moves to the position to dispense the resin to the next imprint target shot region belonging to the second group in parallel to imprint for a shot region belonging to the first group. Additionally, the first dispenser 32 moves to the position to dispense the resin to the next imprint target shot region belonging to the first group in parallel to imprint for a shot region belonging to the second group.

When the apparatus includes only one imprint head, one substrate driving mechanism, and two dispensers for dispensing a resin, as described above, the apparatus cost can be suppressed to low. In addition, employing the above-described imprint procedure brings about an advantage in throughput.

A method of manufacturing a device (e.g., semiconductor integrated circuit device or liquid crystal display device) as an article includes the step of transferring (forming) a pattern to a substrate (e.g., wafer, glass plate, or film-like substrate) using the above-described imprint apparatus. The method can also include the step of etching the substrate with the transferred pattern. Note that to manufacture another article such as a patterned medium (recording medium) or an optical element, the method can include another process step of processing the substrate with the transferred pattern in place of the etching step.

The embodiments of the present invention have been described above. However, the present invention is not limited to the above-described embodiments, and various changes and modifications can be made within the spirit and scope of the present invention.

The present invention is applicable to form a fine pattern to be used to manufacture articles such as semiconductor devices or MEMS (Micro Electro-Mechanical Systems).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-058701, filed Mar. 11, 2009 and Japanese Patent Application No. 2010-030898, filed Feb. 16, 2010, which are hereby incorporated by reference herein in their entirety.

What is claimed is:

1. An imprint apparatus which includes an imprint head configured to hold a mold, and performs an imprint process including dispensing of a resin to a shot region on a substrate and pressing of the mold and the dispensed resin with each other, the apparatus comprising:
a controller configured to control an order of the imprint process for a plurality of selected shot regions on the substrate; and
a first dispenser and a second dispenser configured to dispense the resin,
wherein the first dispenser is arranged on a side of a first direction with respect to the imprint head, and the second dispenser is arranged on a side of a second direction opposite to the first direction with respect to the imprint head,
the substrate is arranged so as to make rows of a layout of the plurality of shot regions parallel with the first direction and the second direction,
the first dispenser dispenses the resin to shot regions belonging to a first group of the layout, and the second dispenser dispenses the resin to shot regions belonging to a second group of the layout, the first group existing on a side of the first direction, the second group existing on a side of the second direction, and a difference between number of shot regions belonging to an rth (r is a natural number) row of the first group and number of shot regions belonging to the rth row of the second group being not more than 1, and
the controller is configured to control the order so as to satisfy
a first condition that if the imprint process has ended for all selected shot regions of one row of the layout, the imprint process is executed for selected shot regions of a next row of the layout,
a second condition that a plurality of shot regions belonging to a rth row selected from the first group undergo the imprint process sequentially in an rth row selected direction that is parallel to the first direction and the second direction,
a third condition that a plurality of shot regions belonging to the rth row selected from the second group undergo the imprint process sequentially in the rth row selected direction, and
a fourth condition that with respect to one row of the layout, the selected shot regions of the first group and the selected shot regions of the second group alternately undergo the imprint process as long as it is possible.

2. The apparatus according to claim 1, wherein the controller is configured to control the order such that if r is an odd number, the rth row selected direction is the first direction, and if r is an even number, the rth row selected direction is the second direction, or
if r is an odd number, the rth row selected direction is the second direction, and if r is an even number, the rth row selected direction is the first direction.

3. The apparatus according to claim 1, wherein
the apparatus is configured such that a first pattern is formed in a plurality of first shot regions of the plurality of shot regions, and a second pattern is formed in a plurality of second shot regions of the plurality of shot regions, the plurality of first shot regions and the plurality of second shot regions being laid out in a checkerboard pattern, and
the controller is configured to control the order such that
the imprint process is performed for the plurality of first shot regions in an order that satisfies the first condition, the second condition, the third condition, and the fourth condition, and
the imprint process is then performed for the plurality of second shot regions in an order that satisfies the first condition, the second condition, the third condition, and the fourth condition.

4. An imprint method using an imprint apparatus which performs an imprint process including dispensing of a resin to a shot region on a substrate and pressing of a mold and the dispensed resin with each other, the imprint apparatus including:
an imprint head configured to hold a mold;
a controller configured to control an order of the imprint process for a plurality of selected shot regions on the substrate; and
a first dispenser and a second dispenser configured to dispense the resin,
wherein the first dispenser is arranged on a side of a first direction with respect to the imprint head, and the second dispenser is arranged on a side of a second direction opposite to the first direction with respect to the imprint head, and
the substrate is arranged so as to make rows of a layout of the plurality of shot regions parallel with the first direction and the second direction,
the method comprising controlling the imprint process such that:
(i) the first dispenser dispenses the resin to shot regions belonging to a first group of the layout, and the second dispenser dispenses the resin to shot regions belonging to a second group of the layout, the first group existing on a side of the first direction, the second group existing on a side of the second direction, and a difference between number of shot regions belonging to an rth (r is a natural number) row of the first group and number of shot regions belonging to the rth row of the second group being not more than 1, and
(ii) the order is controlled to satisfy
a first condition that if the imprint process has ended for all selected shot regions of one row of the layout, the imprint process is executed for selected shot regions of a next row of the layout,
a second condition that a plurality of shot regions belonging to the rth row selected from the first group undergo the imprint process sequentially in an rth row selected direction that is parallel to the first direction and the second direction,
a third condition that a plurality of shot regions belonging to the rth row selected from the second group undergo the imprint process sequentially in the rth row selected direction, and
a fourth condition that with respect to one row of the layout, the selected shot regions of the first group and the selected shot regions of the second group alternately undergo the imprint process as long as it is possible.

5. A method of manufacturing an article, comprising steps of:
forming a pattern of a resin on a substrate using an imprint apparatus of claim 1; and
processing the substrate on which the pattern has been formed.

6. The apparatus according to claim 1, wherein the apparatus is configured such that the first dispenser and the second dispenser are movable, in parallel with the pressing for a shot region of the first group, the second dispenser dispenses the resin to a shot region in the second group to undergo the pressing next, and in parallel with the pressing for a shot region of the second group, the first dispenser dispenses the resin to a shot region in the first group to undergo the pressing next.

7. The apparatus according to claim 1, wherein the apparatus is configured such that the first dispenser and the second dispenser are movable, in parallel to with imprint process for a shot region of the first group, the second dispenser moves to a position to dispenses the resin to a shot region in the second group to undergo the imprint process next, and in parallel with the imprint process for a shot region of the second group, the first dispenser moves to a position to dispense the resin to a shot region in the first group to undergo the imprint process next.

8. An imprint apparatus which performs an imprint process including dispensing of a resin to a shot region on a substrate and pressing of a mold and the dispensed resin with each other, the apparatus comprising:
an imprint head configured to hold the mold and to be driven in a Z-axis direction that is a direction of the pressing;
a driving mechanism configured to hold the substrate and to move the substrate in X- and Y-axis directions perpendicular to each other and perpendicular to the Z-axis direction;
a first dispenser arranged on a side of a positive direction in the X-axis direction with respect to the imprint head and configured to dispense the resin to a shot region;
a second dispenser arranged on a side of a negative direction in the X-axis direction with respect to the imprint head and configured to dispense the resin to a shot region; and
a controller configured to cause the imprint head, the driving mechanism, the first dispenser and the second dispenser to operate, and to control the imprint process for shot regions arranged in the X-axis direction,
wherein the controller is configured
to cause the first dispenser to dispense the resin to first shot regions existing on a side of the positive direction,
to cause the second dispenser to dispense the resin to second shot regions existing on a side of the negative direction, and
to control the imprint process such that the imprint process for one of the first shot regions and the imprint process for one of the second shot regions are alternately performed.

9. The apparatus according to claim 8, wherein the apparatus is configured such that the first dispenser and the second dispenser are movable,
in parallel with the pressing with respect to a shot region of one of the first shot regions and the second shot regions, to a shot region of the other one of the first shot regions and the second shot regions, one of the first dispenser and the second dispenser corresponding to the other one moves for the dispensing.

10. A method of manufacturing an article, comprising steps of:
forming a pattern of a resin on a substrate using an imprint apparatus of claim 8; and
processing the substrate on which the pattern has been formed.
